(19) United States
(12) Patent Application Publication
(10) Pub. No.: US 2022/0045397 A1
(43) Pub. Date: Feb. 10, 2022

(54) BATTERY PACK

(71) Applicant: MURATA MANUFACTURING CO., LTD., Kyoto (JP)

(72) Inventor: Tsuyoshi NAKAMURA, Kyoto (JP)

(21) Appl. No.: 17/484,303

(22) Filed: Sep. 24, 2021

Related U.S. Application Data
(63) Continuation of application No. PCT/JP2020/013404, filed on Mar. 25, 2020.

(30) Foreign Application Priority Data
Mar. 29, 2019 (JP) 2019-068821

(51) Int. Cl. H01M 50/242; B60L 50/64; H01M 50/227

(52) U.S. Cl. CPC H01M 50/242; B25F 5/00; H01M 50/227; B60L 50/64

(57) ABSTRACT

A battery pack includes a battery unit including at least one battery, a case configured to accommodate the battery unit, and a foamed resin member provided between the battery unit and the case. The foamed resin member has a facing portion facing an end surface or a side surface of the battery unit. The facing portion includes a first surface portion and a second surface portion, and at least a part of the second surface portion is harder than the first surface portion and is configured to support the battery unit.

### CROSS REFERENCE TO RELATED APPLICATIONS

The present application is a continuation of PCT patent application no. PCT/JP2020/013404, filed on Mar. 25, 2020, which claims priority to Japanese patent application no. JP2019-068821 filed on Mar. 29, 2019, the entire contents of which are being incorporated herein by reference.

### BACKGROUND

The present disclosure generally relates to a battery pack.

In recent years, a battery pack with a plurality of secondary batteries housed in a case has been used in, for example, devices that require high capacity and high output, and vehicles. Battery packs having various configurations have been investigated.

### SUMMARY

The present disclosure generally relates to a battery pack.

However, the conventional battery pack and the battery module are problematic in that repeat application of an impact load or vibration reduces the impact resistance.

An object of the present disclosure is to provide a battery pack capable of suppressing reduction in impact resistance when an impact load or vibration is repeatedly applied.

In order to solve the above problems, the present disclosure provides a battery pack according to an embodiment including:

a battery unit including at least one battery;

a case configured to accommodate the battery unit; and

a foamed resin member provided between the battery unit and the case.

The foamed resin member includes a facing portion facing an end surface or a side surface of the battery unit; the facing portion includes a first surface portion and a second surface portion; and at least a part of the second surface portion is harder than the first surface portion and is configured to support the battery unit.

The present disclosure can suppress reduction in the impact resistance of a battery pack when an impact load or vibration is repeatedly applied.

It should be understood that the effects described in the present specification are only examples, which do not impose limitations, and additional effects may be further provided.

### BRIEF DESCRIPTION OF THE FIGURES

FIG. 1 is a perspective view showing an example of an appearance of a battery pack according to an embodiment of the present disclosure.

FIG. 2 is a sectional view taken along line II-II of FIG. 1.

FIG. 3A is an exploded perspective view showing an example of a configuration of the battery pack according to an embodiment of the present disclosure.

FIG. 3B is an exploded perspective view showing an example of a configuration of the battery pack according to an embodiment of the present disclosure.

FIG. 4 is an exploded perspective view showing an example of a configuration of the battery pack according to an embodiment of the present disclosure.

FIG. 5 is a perspective view showing an example of a configuration of a foamed resin member.

FIG. 6A is an exploded perspective view showing an example of a configuration of a battery pack according to an embodiment of the present disclosure.

FIG. 6B is an exploded perspective view showing an example of a configuration of the battery pack according to an embodiment of the present disclosure.

FIG. 7 is a perspective view showing an example of a configuration of the foamed resin member according to an embodiment of the present disclosure.

FIG. 8A is an exploded perspective view showing an example of a configuration of a battery pack according to an embodiment of the present disclosure.

FIG. 8B is an exploded perspective view showing an example of a configuration of the battery pack according to an embodiment of the present disclosure.

FIG. 9 is a perspective view showing an example of a configuration of the foamed resin member according to an embodiment of the present disclosure.

FIG. 10 is a perspective view showing a modification example of the foamed resin member according to an embodiment of the present disclosure.

FIG. 11A is a perspective view showing a modification example of the foamed resin member according to an embodiment of the present disclosure.

FIG. 11B is a perspective view showing a modification example of a battery unit according to an embodiment of the present disclosure.

FIG. 12A is a perspective view showing a modification example of the foamed resin member according to an embodiment of the present disclosure.

FIG. 12B is a perspective view showing a modification example of the foamed resin member according to an embodiment of the present disclosure.

FIG. 13 is a schematic view of a power tool as an application example according to an embodiment of the present disclosure.

FIG. 14 is a schematic view of a hybrid vehicle as an application example according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

The present disclosure discloses a cause of reduction in the impact resistance occurs by the following mechanism. That is, when an impact load or vibration is applied to the battery pack, depending on the magnitude of the impact load or vibration, a foamed resin member may be plastically deformed and crushed, and a clearance may be generated between the foamed resin member and the battery unit. When such a clearance occurs and then an impact load or vibration is applied to the battery pack again, the battery unit moves in the battery pack, and the battery unit is damaged.

Therefore, the present disclosure discloses a study on a foamed resin member in order to suppress the occurrence of the clearance as described above. As a result, the present disclosure discloses a foamed resin member including a first surface portion and a second surface portion on a facing surface (facing portion) facing a battery unit, and supporting the battery unit, wherein the second surface portion is harder than the first surface portion. Herein, a battery pack including such a foamed resin member will be described.

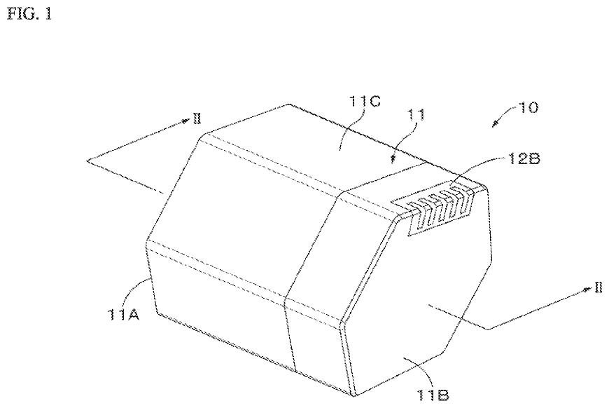

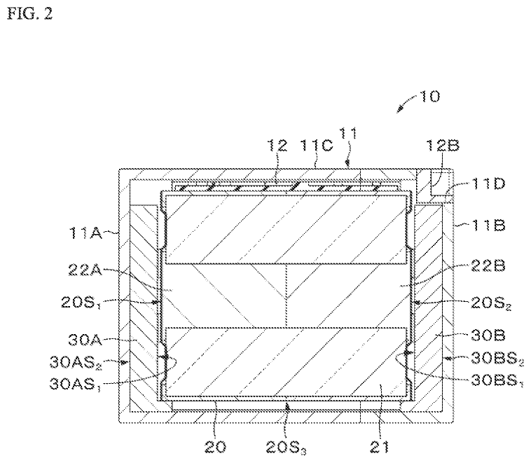

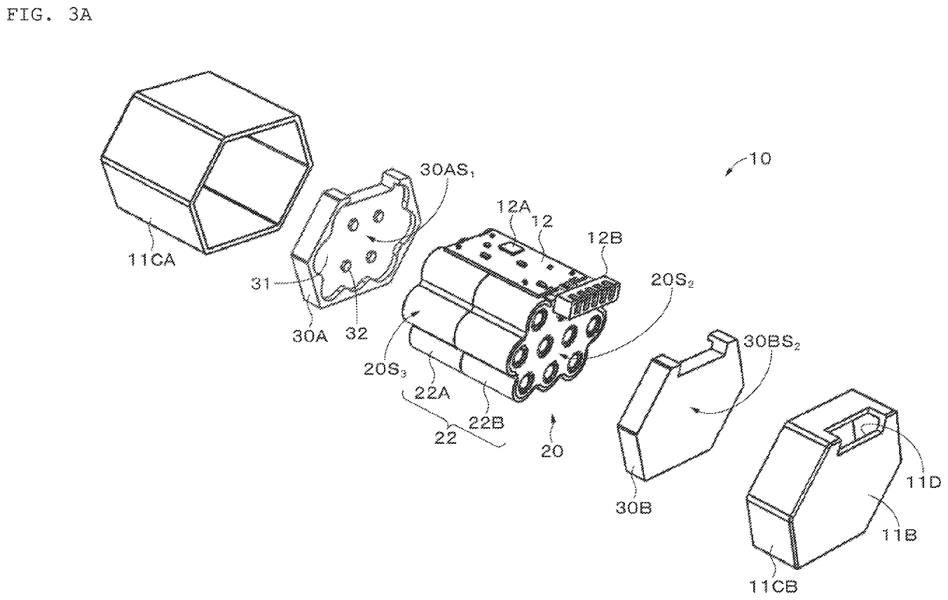

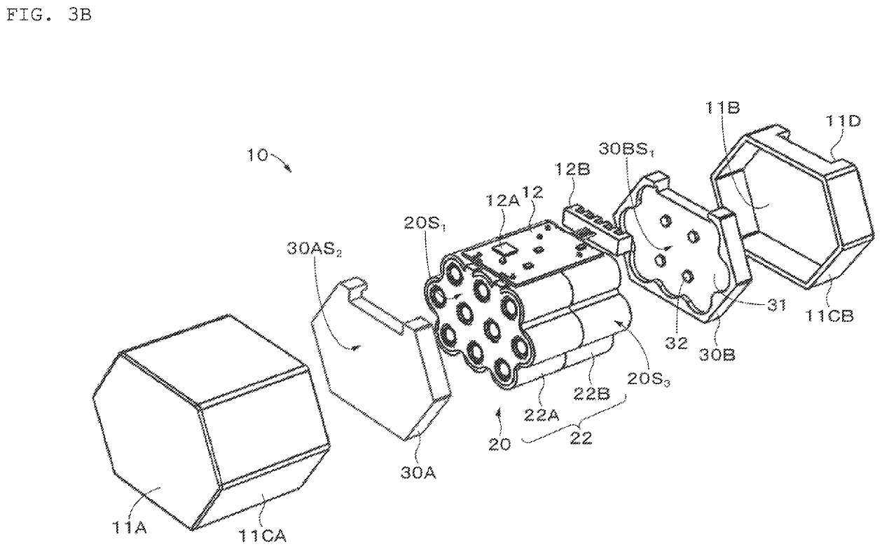

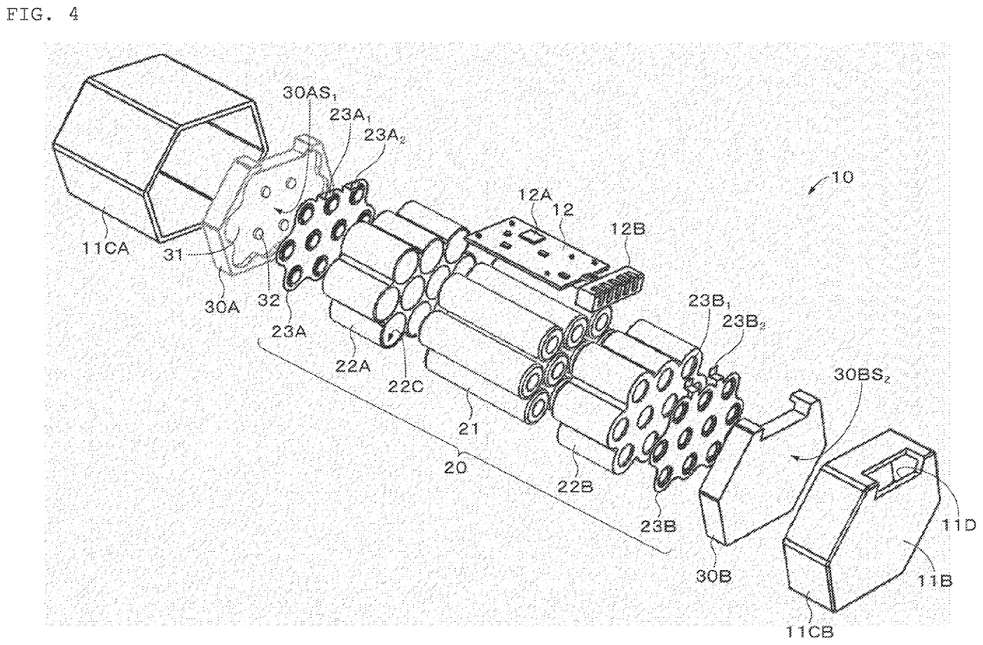

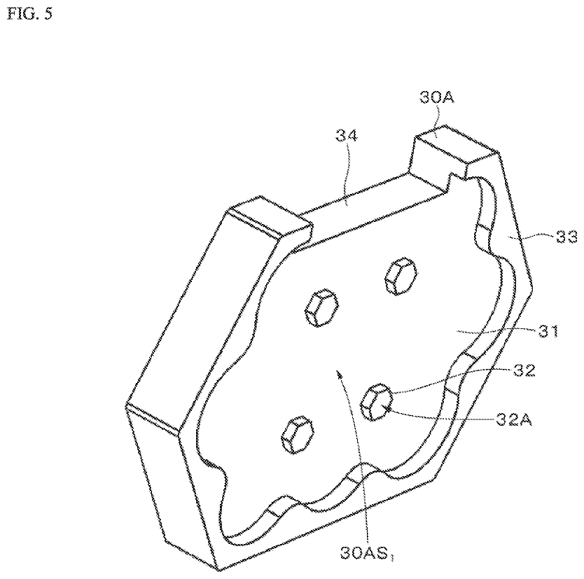

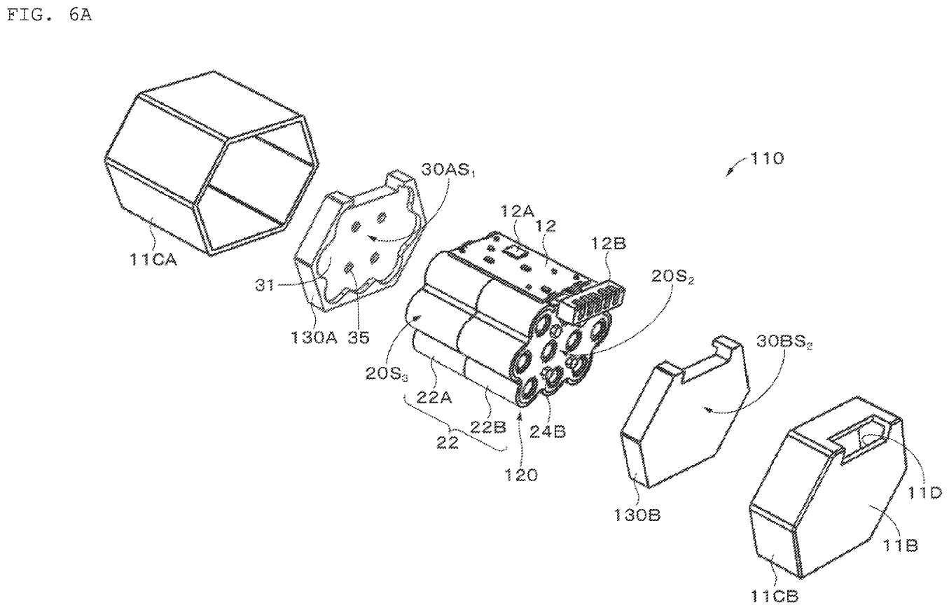

Hereinafter, an example of a configuration of a battery pack 10 according to the first embodiment of the present disclosure will be described with reference to FIG. 1, FIG. 2, FIG. 3A, FIG. 3B, FIG. 4, and FIG. 5. In the present description, the exploded perspective views of FIG. 3A, FIG. 3B, FIG. 4, and the like are exploded perspective views in a state before the battery pack 10 is assembled. As shown in FIG. 1, FIG, 2, FIG. 3A, and FIG. 3B, the battery pack 10 includes a battery unit 20, a case 11, foamed resin members 30A and 30B, and a substrate 12. The battery pack 10 has, for example, a prismatic shape such as a hexagonal prism shape. The shape of the battery pack 10 is not limited thereto, and may be, for example, a cylindrical shape, an elliptical columnar shape, a polyhedral shape, a spherical shape, an elliptical spherical shape, or a free-form surface shape.

A battery pack 10 is used for, for example, an electric device. Examples of the electric device include an electric motorcycle, an electric bicycle, an electric assist bicycle, a hybrid car, or a power tool (such as an electric tool); however, are not limited thereto.

A battery unit 20 has a first end surface portion 20S₁ and a second end surface portion 20S₂ facing each other, and a peripheral surface portion 20S₃ provided between the first end surface portion 20S₁ and the second end surface portion 20S₂. As shown in FIG. 4, the battery unit 20 includes a plurality of batteries 21, a holder 22, and tabs 23A and 23B. The holder 22 is provided as necessary, and may not be provided.

A battery 21 is a cylindrical battery having a first end portion and a second end portion. The first end portion is, for example, a positive electrode terminal portion, and the second end portion is, for example, a negative electrode terminal portion. A plurality of the batteries 21 are arranged such that the central axes of the batteries 21 are parallel to each other. The plurality of the batteries 21 are arranged so as to have a plurality of columns, for example. The plurality of the batteries 21 may be arranged in a barrel stack in which two adjacent columns of the batteries 21 are shifted from each other in the column direction by substantially the same length as the radius of the outer diameter circumference of the battery 21.

The first end portions of a plurality of batteries 21 are arranged on a side of a first end surface portion 20S₁ of a battery unit 20, and the second end portions of the plurality of the batteries 21 are arranged on a side of a second end surface portion 20S₂ of the battery unit 20. The battery 21 is, for example, a repeatedly usable secondary battery. Examples of the secondary battery include a lithium-ion secondary battery or a lithium-ion polymer secondary battery; however, are not limited thereto.

A holder 22 holds a plurality of batteries 21. The holder 22 is composed of, for example, a resin material, The holder 22 has a plurality of hole portions 22C provided between a first end surface portion 20S₁ and a second end surface portion 20S₂. The hole portion 22C is a columnar space having substantially the same size as the battery 21, and houses the battery 21. The plurality of hole portions 22C are provided such that the central axis of each hole portion 22C is orthogonal to the first end surface portion 20S₁ and the second end surface portion 20S₂. Both ends of the hole portion 22C are opened, and the first and second end portions of the battery 21 housed in the hole portion 22C are exposed from the holder 22. The holder 22 is configured to be dividable into a first holder 22A and a second holder 22B at an intermediate position between the first end surface portion 20S₁ and the second end surface portion 20S₂.

A tab 23A electrically connects the first end portions of a plurality of batteries 21 held by a holder 22 to a substrate 12. A tab 23B electrically connects the second end portions of the plurality of the batteries 21 held by the holder 22 to the substrate 12. The tabs 23A and 23B electrically connect the plurality of the batteries 21 in parallel, The connection form of the plurality of the batteries 21 is not limited to parallel, and the plurality of the batteries 21 may be connected in series or in series and parallel.

Tabs 23A and 23B have a thin plate shape and are composed of a conductive material such as metal. One main surface of the tab 23A is provided on a first end surface portion 20S₁ of battery unit 20. One main surface of the tab 23B is provided on a second end surface portion 20S₂ of holder 22. The tab 23A has terminal portions 23A₁ and 23A₂ extending from the peripheral edge portion. The tab 23B has terminal portions 23B₁ and 23B₂ extending from the peripheral edge portion. The terminal portions 23A₁ and 23A₂ and the terminal portions 23B₁ and 23B₂ protrude in the same direction from a peripheral surface portion 20S₃ of the battery unit 20. The terminal portions 23A₁ and 23A₂ electrically connect the tab 23A to a substrate 12, and the terminal portions 23B₁ and 23B₂ electrically connect the tab 23B to the substrate 12. The terminal portions 23A₁ and 23A₂ and the terminal portions 23B₁ and 23B₂ also have a function of supporting the substrate 12 on the peripheral surface portion 20S₃ of the battery unit 20.

A substrate 12 electrically connects an external device (not shown) such as an electric device to battery unit 20. The substrate 12 is provided on a peripheral surface portion 20S₃ of the battery unit 20, and is supported by terminal portions 23A₁ and 23A₂ of a tab 23A and terminal portions 23B₁ and 23B₂ of a tab 23B.

A substrate 12 has, for example, a rectangular shape, and includes a control unit 12A and a connector 12B. The control unit 12A is electrically connected to terminal portions 23A₁ and 23A₂ of a tab 23A and terminal portions 23B₁ and 23B₂ of a tab 23B with wiring (not shown) interposed therebetween. The control unit 12A is electrically connected to the connector 12B with wiring (not shown) with interposed therebetween.

A control unit (controller) 12A controls battery unit 20. The control unit 12A includes, for example, a charge and discharge control integrated circuit (IC). The control unit 12A may further include at least one of a battery protection and a remaining battery level monitoring IC as necessary. The charge and discharge control IC controls charge and discharge of the battery unit 20. The battery protection IC suppresses thermal runaway of a battery 21 and protects the battery 21 when the battery 21 is in an abnormal state or the like. The remaining battery level monitoring IC monitors the remaining level of each battery 21.

A connector 12B is an example of an external connection terminal that connects a battery pack 10 to an external device (not shown). The connector 12B is provided so as to protrude against a first end surface portion 20S₁ of a battery unit 20.

A case 11 houses a battery unit 20, a substrate 12, and foamed resin members 30A and 30B. The case 11 protects the battery unit 20 from an impact due to, for example, falling, or an external environment. The case 11 is composed of, for example, polymer resin or metal. The case 11 may be composed of a laminate with a polymer resin layer and a metal layer laminated.

As shown in FIG. 1 and FIG. 2, a case 11 includes a wall portion 11C having a cylindrical shape, a first end surface portion 11A that closes the first opening end portion of the wall portion 11C, and a second end surface portion 11B that closes the second opening end portion of the wall portion 11C. The wall portion 11C covers a peripheral surface portion 20S₃ of battery unit 20. A section obtained by cutting the wall portion 11C perpendicularly to the central axis thereof has, for example, a hexagonal shape. However, the sectional shape of the wall portion 11C is not limited thereto, and may be, for example, a polygonal shape other than a hexagonal shape, a circular shape, a cylindrical shape, or an irregular shape.

A first end surface portion 11A is provided to face a first end surface portion 20S₁ of a battery unit 20, and covers the first end surface portion 20S₁ of the battery unit 20. A second end surface portion 11B is provided to face a second end surface portion 20S₂ of the battery unit 20, and covers the second end surface portion 20S₂ of the battery unit 20.

A case 11 is configured to be separable into a case body 11CA having a first end surface portion 11A and a lid portion 11CB having a second end surface portion 11B at a position closer to the second end surface portion 11B than an intermediate position between a first end surface portion 11A and the second end surface portion 11B. The case 11 has an opening portion 11D. A connector 12B is exposed from the opening portion 11D.

Foamed resin members 30A and 30B have a function as a buffer member that buffers an external force transmitted from a case 11 to a battery 21. In addition, the foamed resin members 30A and 30B have a function as a holding member that holds a battery unit 20 at a fixed position in a case 11.

Foamed resin members 30A and 30B are provided in a space between a case 11 and a battery unit 20. More specifically, the foamed resin member 30A is provided between a first end surface portion 11A of the case 11 and a first end surface portion 20S₁ of the battery unit 20. The foamed resin member 30B is provided between a second end surface portion 11B of the case 11 and a second end surface portion 20S₂ of the battery unit 20.

Foamed resin members 30A and 30B are composed of, for example, an aggregate of foamed beads foamed by steam heating. The foamed resin members 30A and 30B mainly include at least one selected from the group consisting of, for example, a polyphenylene ether (PPE)-based resin, a polystyrene (PS)-based resin, and an olefin-based resin (for example, polypropylene, polyethylene). The foamed resin members 30A and 30B may include additives as necessary.

Foamed resin member 30A is a plate-shaped member, and has a first main surface portion 30AS₁ facing a first end surface portion 20S₁ of a battery unit 20 and a second main surface portion 30AS₂ facing a first end surface portion 11A of a case 11. Foamed resin member 30B is a plate-shaped member, and has a first main surface portion 30BS₁ facing a second end surface portion 20S₂ of the battery unit 20 and a second main surface portion 30BS₂ facing a second end surface portion 11B of the case 11. The foamed resin member 30B has the same configuration as the foamed resin member 30A, and therefore only the configuration of the foamed resin member 30B will be described below.

As shown in FIG. 5, a first main surface portion 30AS₁ of a foamed resin member 30A has a flat portion 31, one or two or more protrusion portions 32 protruding toward a first end surface portion 20S₁ of a battery unit 20, and a peripheral wall portion 33 protruding toward a peripheral edge portion of a first end surface portion 20S₁ of the battery unit 20.

A flat portion 31 is configured to be elastically deformable. The flat portion 31 alleviates impact and vibration applied to a first end surface portion 20S₁ of a battery unit 20. The flat portion 31 corresponds to a specific example of a “first surface portion” of the present disclosure. The first surface portion is not limited to the flat portion 31, and may be, for example, an uneven surface portion. However, when the protrusion portion is provided on the first surface portion, the height of the protrusion portion needs to be set lower than the height from the flat portion 31 to the top portion of a protrusion portion 32.

A protrusion portion 32 supports a first end surface portion 20S₁ of a battery unit 20. A top portion 32A of the protrusion portion 32 is harder than a flat portion 31. More specifically, the foamed resin constituting the top portion 32A of the protrusion portion 32 has a lower foam density than the foamed resin constituting the flat portion 31. The foam density means the total volume of bubbles included per unit volume. When the foamed resin is plastically deformed, the bubbles of the foamed resin are crushed, and the foam density (the total volume of the bubbles included per unit volume) decreases. Therefore, when the foam density is low, the foamed resin becomes hard. The protrusion portion 32 corresponds to a specific example of the “second surface portion” of the present disclosure. In the present description, “hardness” means indentation hardness.

The side surface of a protrusion portion 32 may be harder than a flat portion 31. More specifically, the side surface of the protrusion portion 32 may be composed of a foamed resin having a lower foam density than the flat portion 31. In order to suppress reduction in the impact resistance of a battery pack 10 when an impact load or vibration is repeatedly applied, a top portion 32A of the protrusion portion 32 is preferably plastically deformed. The protrusion portion 32 is, for example, integrally molded with the main body of a foamed resin member 30A. Examples of the shape of the protrusion portion 32 include a columnar shape (for example, a cylindrical shape or a prismatic shape), a conical shape, a polyhedral shape, a hemispherical shape, or a semi-elliptical shape however, are not limited to these shapes. Two or more protrusion portions 32 may be regularly arranged on a first main surface portion 30AS₁ of the foamed resin member 30A, or may be randomly arranged.

Examples of the method of hardening a top portion 32A of a protrusion portion 32 as compared with a flat portion 31 (that is, the method of lowering the foam density of the foamed resin constituting the top portion 32A of the protrusion portion 32 as compared with the foam density of the foamed resin constituting the flat portion 31) include: a method of pressing a first end surface portion 20S₁ of a battery unit 20 against the protrusion portion 32 to compress and preferably plastically deform the protrusion portion 32 in assembling a battery pack 10; and a method of pressing a pressing body against the protrusion portion 32 to compress and plastically deform the protrusion portion 32 before assembling the battery pack 10, and the former is preferable. When the former is adopted, the dimensional tolerance of each component of the battery pack 10 can be absorbed by compressing and plastically deforming the protrusion portion 32.

It is confirmed by, for example, the following procedure that a top portion 32A of a protrusion portion 32 is harder than a flat portion 31. A probe (measurement rod) of a push pull gauge is pushed into the flat portion 31 by 0.3 mm, 0.6 mm, and 1.0 mm, the resultant loads are measured respectively, and these measured values are simply averaged (arithmetically averaged) to determine an average value WA of the pushing load of the flat portion 31. Similarly, a probe (measurement rod) of a push pull gauge is pushed into the top portion 32A of the protrusion portion 32 by 0.3 mm, 0.6 mm, and 1.0 mm, the resultant loads are measured respectively, and these measured values are simply averaged (arithmetically averaged) to determine an average value WB of the pushing load of the top portion 32A of the protrusion portion 32. Then, it is determined whether or not the top portion 32A of the protrusion portion 32 is harder than the flat portion 31 by comparing the average value WA of the pushing load of the flat portion 31 with the average value WB of the pushing load of the top portion 32A of the protrusion portion 32. When the weighted average values WA and WB satisfy the relationship of WA>WB, it is determined that the top portion 32A of the protrusion portion 32 is harder than the flat portion 31.

The side of a first end surface portion 20S₁ of a battery unit 20 is fitted inside a peripheral wall portion 33. This fixes the position of the battery unit 20 in a battery pack 10, The peripheral wall portion 33 is provided along the peripheral edge portion of a first main surface portion 30AS₁ of a foamed resin member 30A. The peripheral wall portion 33 may be continuously provided along the peripheral edge portion of the first main surface portion 30AS_{1,} or may be discontinuously provided along the peripheral edge portion of the first main surface portion 30AS₁.

The top portion of a peripheral wall portion 33 may have the same hardness as a flat portion 31 or may be harder than the flat portion 31. That is, the foam density of the foamed resin material constituting the top portion of the peripheral wall portion 33 may be the same as or substantially the same as the foam density of the foamed resin constituting the flat portion 31, or may be lower than the foam density of the foamed resin constituting the flat portion 31.

A second main surface portion 30AS₂ of a foamed resin member 130A preferably has the same hardness as a flat portion 31. Specifically, the foamed resin constituting the second main surface portion 30AS₂ preferably has the same or substantially the same foam density as the foamed resin constituting the flat portion 31. This can improve absorption of impact and vibration applied to a first end surface portion 11A of a case 11. The second main surface portion 30AS₂ is, for example, a flat portion.

The side surface portion of a foamed resin member 30A has a recess portion 34 recessed away from the inner surface of a case 11. The recess portion 34 supports a connector 12B. In the first embodiment, the connector 12B is provided on the side of a foamed resin member 30B, and therefore the recess portion 34 of the foamed resin member 30A may not be provided. In the first embodiment, the foamed resin members 30A and 30B have the same configuration in consideration of productivity, and therefore both the foamed resin members 30A and 30B have the recess portion 34.

In a battery pack 10 according to the first embodiment, a foamed resin member 30A has a first main surface portion 30AS₁ facing a first end surface portion 20S₁ of a battery unit 20; the first main surface portion 30AS₁ includes a flat portion (first surface portion) 31 and a protrusion portion (second surface portion) 32; and a top portion 32A of the protrusion portion 32 is harder than the flat portion 31 and supports the first end surface portion 20S₁ of the battery unit 20. In addition, a foamed resin member 30B has a first main surface portion 30BS₁ facing a second end surface portion 20S₂ of the battery unit 20; the first main surface portion 30BS₁ includes the flat portion (first surface portion) 31 and the protrusion portion (second surface portion) 32; and the top portion 32A of the protrusion portion 32 is harder than the flat portion 31 and supports a second end surface portion 20S₂ of the battery unit 20. As a result, when an impact or vibration is repeatedly applied to the battery pack 10, it is possible to suppress plastic deformation of the first main surface portion 30AS₁ of the foamed resin member 30A and the first main surface portion 30BS₁ of the foamed resin member 30B. Therefore, it is possible to suppress generation of clearances between the foamed resin member 30A and the first end surface portion 20S₁ of the battery unit 20 and between the foamed resin member 30B and the second end surface portion 20S₂ of the battery unit 20. Therefore, it is possible to suppress reduction in the impact resistance of the battery pack 10 when an impact load or vibration is repeatedly applied to the battery pack 10.

In addition, in a battery pack 10 according to the first embodiment, a foamed resin member 30A is filled into a space between a first end surface portion 20S₁ of a battery unit 20 and a first end surface portion 11A of a case 11. In addition, a foamed resin member 30B is filled into a space between a second end surface portion 20S₂ of the battery unit 20 and a second end surface portion 11B of the case 11. As a result, it is possible to suppress displacement of the first end surface portion 11A and the second end surface portion 11B of the case 11 when an impact load or vibration is applied to the battery pack 10. Therefore, it is possible to suppress the occurrence of cracks in the first end surface portion 11A and the second end surface portion 11B of the case 11. Thus, the battery pack 10 can be protected from impact and vibration.

In addition, foamed resin members 30A and 30B hardly transmit vibration applied to a battery pack 10 from the outside to a battery unit 20 as compared with a non-foamed resin member (for example, a highly elastic rubber-based non-foamed resin member used as a cushioning material in a general battery pack), and therefore the battery unit 20 can be protected from the vibration.

In addition, foamed resin members 30A and 30B are lower in density and lighter than non-foamed resin members (for example, a highly elastic rubber-based non-foamed resin member used as a cushioning material in a general battery pack), and therefore the weight of a battery pack 10 can be reduced.

In addition, in a battery pack 10 according to the first embodiment, a battery 21 is housed in a holder (structural component) 22 having a smaller dimensional tolerance than the battery 21, and the dimensional tolerance of each battery 21 is absorbed by the holder 22. Therefore, it is possible to suppress the variation of the elastic force applied by foamed resin members 30A and 30B to a battery unit 20 with a protrusion portion 32 interposed therebetween in each battery pack 10. Therefore, it is possible to suppress the occurrence of a difference in the impact resistance among the battery packs 10. Contrary to this, the configuration of not housing the battery 21 in the holder 22 as in Patent Document 2 increases a variation in elastic force applied to each battery 21 by the foamed resin. Therefore, each battery pack tends to have a difference in impact resistance. The dimensional tolerance of the structural parts such as the holder 22 is generally smaller than the dimensional tolerance of the battery 21.

In addition, when impact or vibration is applied to a battery pack 10 to deform a case 11, housing a battery 21 in a holder 22 can protect the battery 21 from such deformation.

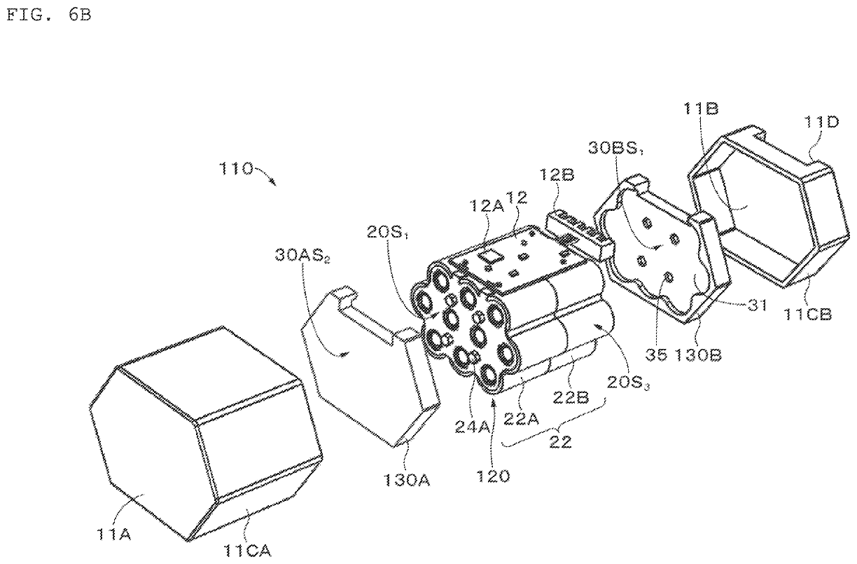

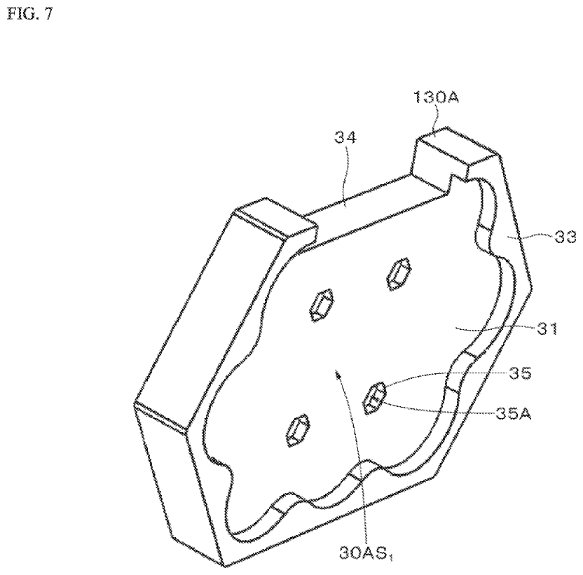

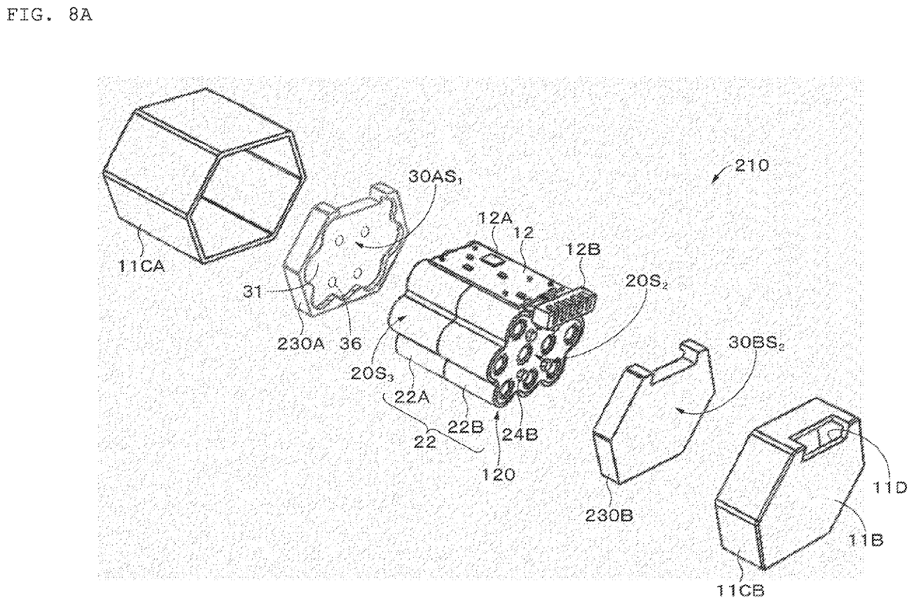

An example of a configuration of a battery pack 110 according to the second embodiment of the present disclosure will be described with reference to FIG. 6A, FIG. 6B, and FIG. 7. In the second embodiment, the same reference numerals are given to the same parts as those of the first embodiment, and the explanation thereof will be omitted.

A first end surface portion 20S₁ of a battery unit 120 has one or two or more protrusion portions 24A protruding toward a first main surface portion 30AS₁ of a foamed resin member 30A. In addition, a second end surface portion 20S₂ of the battery unit 120 has one or two or more protrusion portions 24B protruding toward a first main surface portion 30BS₁ of a foamed resin member 30B.

A protrusion portion 24A has a function as a pusher that presses a first main surface portion 30AS₁ of a foamed resin member 130A and plastically deforms the first main surface portion into preferably a recess shape in assembling a battery pack 110. A protrusion portion 24B has a function as a pusher that presses a first main surface portion 30BS₁ of a foamed resin member 130B and plastically deforms the first main surface portion into preferably a recess shape in assembling the battery pack 110.

A protrusion portion 24A is configured by, for example, protruding a part of a holder 22 toward a first main surface portion 30AS₁ of a foamed resin member 30A. The configuration of this case is that a tab 23A has one or two or more through holes (not shown), and the protrusion portion 24A protrudes with this through hole interposed therebetween. The protrusion portion 24A may be configured by protruding a part of the tab 23A toward the first main surface portion 30AS₁ of the foamed resin member 30A. A protrusion portion 24B is configured in the same manner as the protrusion portion 24A described above.

A first main surface portion 30AS₁ of a foamed resin member 130A has one or two or more recess portions 35 recessed in a direction away from a first end surface portion 20S₁ of a battery unit 120. A foamed resin member 130E has the same configuration as the foamed resin member 130A, and therefore the explanation of the configuration of the foamed resin member 130B is omitted.

A recess portion 35 houses a protrusion portion 24A of a foamed resin member 130A. The top portion of the protrusion portion 24A of a battery unit 120 is pressed against a bottom portion 35A of the recess portion 35. The bottom portion 35A of the recess portion 35 supports a first end surface portion 20S₁ of the battery unit 120 with a protrusion portion 24B interposed therebetween. The bottom portion 35A of the recess portion 35 is harder than a flat portion 31. More specifically, the foamed resin constituting the bottom portion 35A of the recess portion 35 has a lower foam density than the foamed resin constituting the flat portion 31. The recess portion 35 corresponds to a specific example of the “second surface portion” of the present disclosure.

The side surface of a recess portion 35 may be harder than a flat portion 31. More specifically, the side surface of the recess portion 35 may be composed of a foamed resin having a lower foam density than the flat portion 31. In order to suppress reduction in the impact resistance of a battery pack 10 when an impact load or vibration is repeatedly applied, a bottom portion 35A of the recess portion 35 is preferably plastically deformed. Examples of the shape of the recessed space of the recess portion 35 can include the same shape as a protrusion portion 32 in the above-described first embodiment. Two or more recess portions 35 may be regularly arranged on a first main surface portion 30AS₁ of a foamed resin member 130A, or may be randomly arranged.

A recess portion 35 of a foamed resin member 130A is formed by, for example, pressing a protrusion portion 24A of a first end surface portion 20S₁ of a battery unit 120 against a first main surface portion 30AS₁ of a foamed resin member 30A to compress the protrusion portion into a recess shape and preferably plastically deform the concave portion in assembling a battery pack 110. Thus, the recess portion 35 is formed by compressing the first main surface portion 30AS₁, allowing a bottom portion 35A of the recess portion 35 to be harder than a flat portion 31.

In a battery pack 110 according to the second embodiment, a foamed resin member 130A has a first main surface portion 30AS₁ facing a first end surface portion 20S₁ of a battery unit 120; the first main surface portion 30AS₁ includes a flat portion (first surface portion) 31 and a protrusion portion (second surface portion) 35; and a bottom portion 35A of a recess portion 35 is harder than the flat portion 31 and supports the first end surface portion 20S₁ of the battery unit 120 with a protrusion portion 24A interposed therebetween. In addition, a foamed resin member 130B has a first main surface portion 30BS₁ facing a second end surface portion 20S₂ of the battery unit 120; the first main surface portion 30BS₁ includes the flat portion (first surface portion) 31 and the recess portion (second surface portion) 35; and a bottom portion 35A of the recess portion 35 is harder than the fiat portion 31 and supports the second end surface portion 20S₂ of the battery unit 120 with a protrusion portion 24B interposed therebetween. As a result, when an impact or vibration is repeatedly applied to the battery pack 110, it is possible to suppress plastic deformation of the first main surface portion 30AS₁ of the foamed resin member 130A and the first main surface portion 30BS₁ of the foamed resin member 130B. Therefore, it is possible to suppress reduction in the impact resistance of the battery pack 110 when an impact load or vibration is repeatedly applied to the battery pack 110. Furthermore, the protrusion portion 24A of the battery unit 120 bites into the recess portion 35 of the foamed resin member 130A and the protrusion portion 24B of the battery unit 120 bites into the recess portion 35 of the foamed resin member 130B, and therefore the holding force against the lateral misalignment of the battery unit 120 is improved.

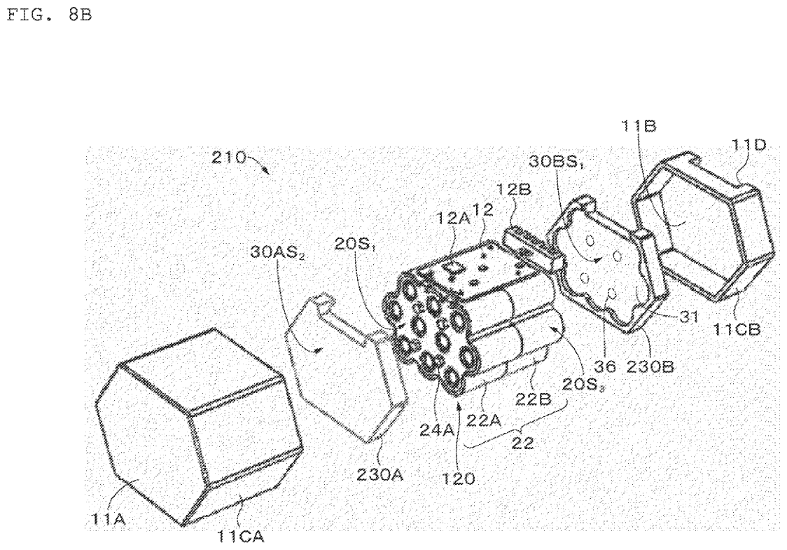

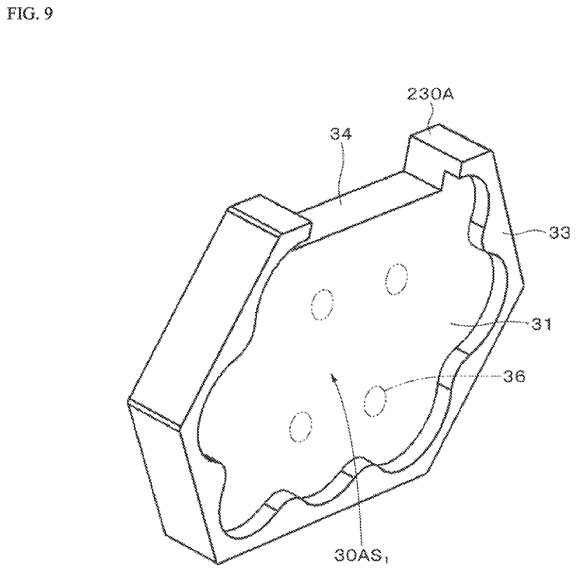

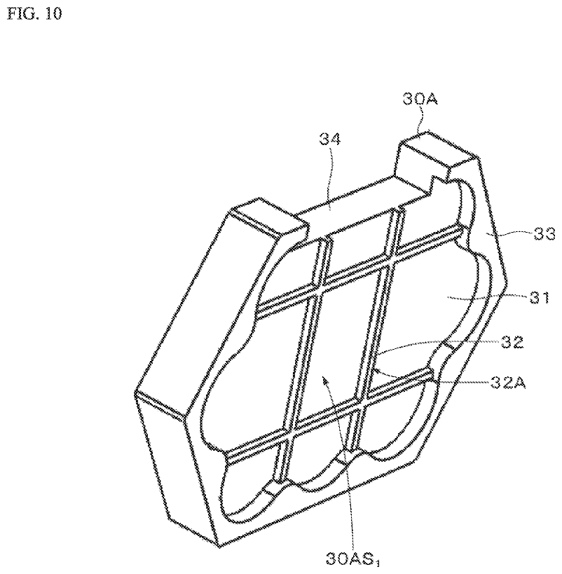

An example of a configuration of a battery pack 210 according to the third embodiment of the present disclosure will be described with reference to FIG. 8A, FIG. 8B, and FIG. 9. In the third embodiment, the same reference numerals are given to the same parts as those of the first embodiment or the second embodiment, and the explanation thereof will be omitted.

A first main surface portion 30AS₁ of a foamed resin member 230A has one or two or more flat portions 36 configured to be flush with a flat portion 31. A foamed resin member 230B has the same configuration as the foamed resin member 230A, and therefore the explanation of the configuration of the foamed resin member 230B is omitted.

A flat portion 36 is harder than a flat portion 31. More specifically, the foamed resin constituting the flat portion 36 has a lower foam density than the foamed resin constituting the flat portion 31. The flat portion 36 corresponds to a specific example of a “second surface portion” of the present disclosure. The portion including the flat portion 36 is, for example, integrally molded with the other portion of a foamed resin member 30A. In order to suppress reduction in the impact resistance of a battery pack 210 when an impact load or vibration is repeatedly applied, the flat portion 36 is preferably plastically deformed. Examples of the shape of the flat portion 36 include a polygonal shape, a circular shape, an elliptical shape, or an irregular shape; however, are not limited to these shapes. Two or more flat portions 36 may be regularly arranged on a first main surface portion 20AS₁ of a foamed resin member 230A, or may be randomly arranged.

Each of flat portions 36 are provided at a position facing a protrusion portion 24A of a first end surface portion 20S₁ of a battery unit 120. The protrusion portion 24A is pressed against at least a part of the flat portion 36. At least a part, of the flat portion 36 is in contact with the protrusion portion 24A. The flat portion 36 supports the first end surface portion 20S₁ of the battery unit 120 with the protrusion portion 24A interposed therebetween.

A flat portion 36 of a foamed resin member 230A is formed, for example, as follows in assembling a battery pack 210. There is prepared the foamed resin member 230A provided with a protrusion portion at a position corresponding to the flat portion 36 in a first main surface portion 30AS₁. A protrusion portion 24A of a first end surface portion 20S₁ of the battery pack 210 is pressed and compressed against the protrusion portion provided on the first main surface portion 30AS₁, preferably plastically deformed, and the protrusion portion is crushed to be formed into the flat portion 36.

In a battery pack 210 according to the third embodiment, a foamed resin member 230A has a first main surface portion 30AS₁ facing a first end surface portion 20S₁ of a battery unit 120; the first main surface portion 30AS₁ includes a flat portion (first surface portion) 31 and a flat portion (second surface portion) 36; and the flat portion 36 is harder than the fiat portion 31 and supports the first end surface portion 20S₁ of the battery unit 120 with a protrusion portion 24A interposed therebetween. In addition, a foamed resin member 30B has a first main surface portion 30BS₁ facing a second end surface portion 20S₂ of the battery unit 120; the first main surface portion 30BS₁ includes the flat portion (first surface portion) 31 and the flat portion (second surface portion) 36; and the flat portion 36 is harder than the flat portion 31 and supports second end surface portion 20S₂ of the battery unit 120 with a protrusion portion 24B interposed therebetween. As a result, when an impact or vibration is repeatedly applied to the battery pack 210, it is possible to suppress plastic deformation of the first main surface portion 30AS₁ of the foamed resin member 230A and the first main surface portion 30BS₁ of a foamed resin member 230B. Therefore, it is possible to suppress reduction in the impact resistance of a battery pack 10 when an impact load or vibration is repeatedly applied to the battery pack 210. Furthermore, it is not necessary to accurately perform alignment for fitting the protrusion and recess portions of the foamed resin members 230A and 230B and the battery unit 120, and therefore workability in incorporating the battery unit 120 is improved.

The first to third embodiments of the present disclosure have been specifically described above, the present disclosure is not limited to the first to third embodiments described above, and various modifications based on the technical idea of the present disclosure are possible.

For example, the configurations, methods, steps, shapes, materials, and numerical values described in the first to third embodiments are merely examples, and different configurations, methods, steps, shapes, materials, and numerical values may be used as necessary.

In addition, the configurations, methods, steps, shapes, materials, and numerical values of the first to third embodiments described above can be combined with each other without departing from the gist of the present disclosure.

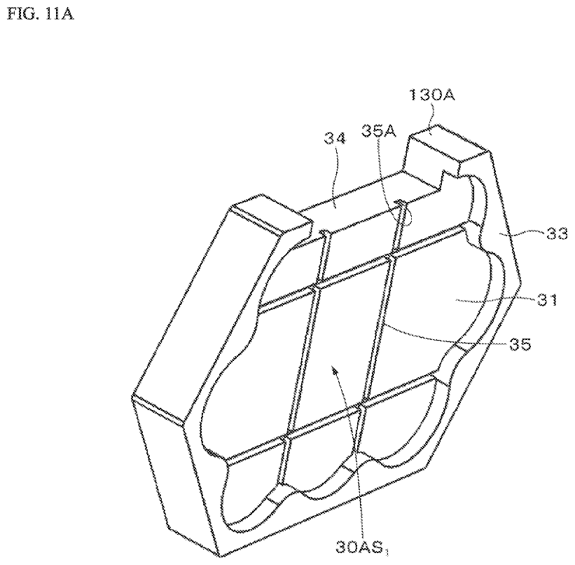

The first embodiment described above has described the case where one or two or more protrusion portions 32 provided on a first main surface portion 30AS₁ of a foamed resin member 30A and a first main surface portion 30BS₁ of a foamed resin member 30B have a columnar shape and a conical shape; however, the shape of the protrusion portion 32 is not limited thereto. For example, the protrusion portion 32 may have a linear shape as shown in FIG. 10.

Examples of the arrangement form of two or more linear protrusion portions 32 include a stripe shape, a lattice shape, a concentric shape, a spiral shape, and a geometric pattern shape; however, are not limited to these arrangement forms. The line is not limited to a straight line, and may be curved or meandering. In addition, the line may be continuous or may be divided in part and discontinuous. Examples of the sectional shape obtained by cutting the protrusion portion 32 in a direction perpendicular to the extending direction of the protrusion portion 32 include a polygonal shape (for example, a triangular shape, a rectangular shape, and a trapezoidal shape), a parabolic shape, a semicircular shape, or a semi-elliptical shape; however, are not limited to these shapes.

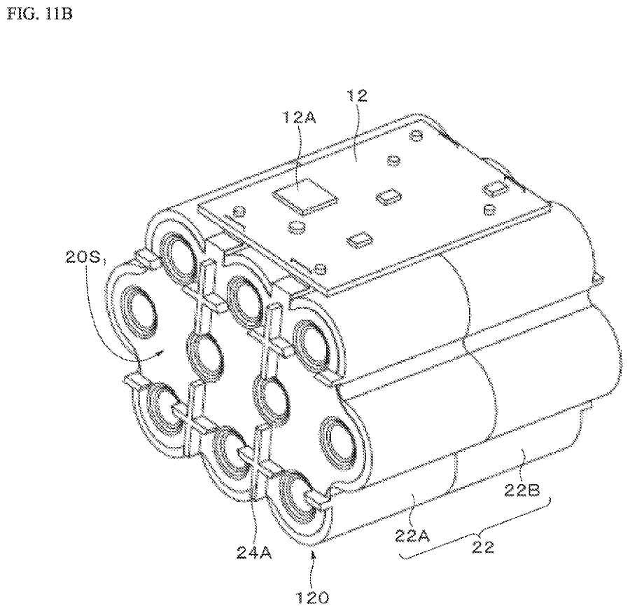

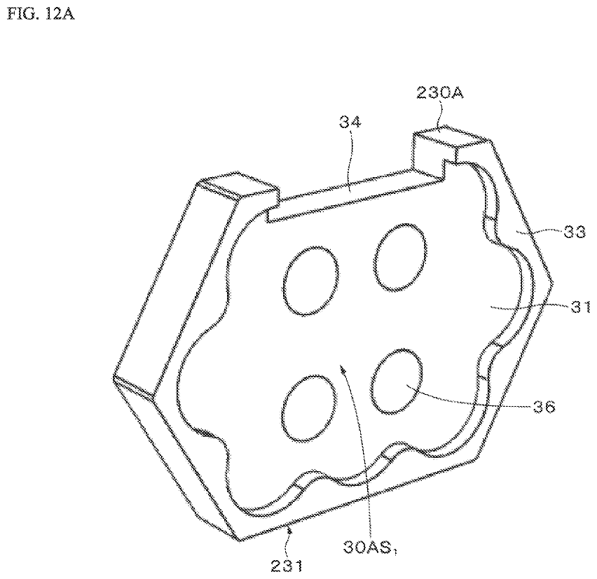

The second embodiment described above has described the case where one or two or more recess portions 35 provided on a first main surface portion 30AS₁ of a foamed resin member 130A and a first main surface portion 30BS₁ of a foamed resin member 130B have a recessed space such as a columnar shape or a conical shape; however, the shape of the recess portion 35 is not limited thereto. For example, the recessed space of the recess portion 35 may have a linear shape as shown in FIG. 11A. In this case, one or two or more protrusion portions 24A provided on a first end surface portion 20S₁ of a battery unit 120 may also have a linear shape as shown in FIG. 11B. In addition, one or two or more protrusion portions 24B provided on a second end surface portion 20S₂ of the battery unit 120 may also have a linear shape, not shown in figure. With such a configuration, the recess portion 35 of the foamed resin member 130A and the protrusion portion 24A of the battery unit 120 bite into each other, and the recess portion 35 of the foamed resin member 130B and the protrusion portion 24B of the battery unit 120 bite into each other, and therefore the holding force against the lateral misalignment of the battery unit 120 is improved.

Examples of the arrangement form of two or more linear recess portions 35 and the arrangement form of two or more linear protrusion portions 24A can include the same arrangement form as a protrusion portion 32 in modification example 1 described above. Examples of the sectional shape obtained by cutting the recess portion 35 in a direction perpendicular to the extending direction of the recess portion 35 and the sectional shape obtained by cutting the protrusion portion 24A in a direction perpendicular to the extending direction of the protrusion portion 24A can include the same sectional shape as the protrusion portion 32 in modification example 1 described above.

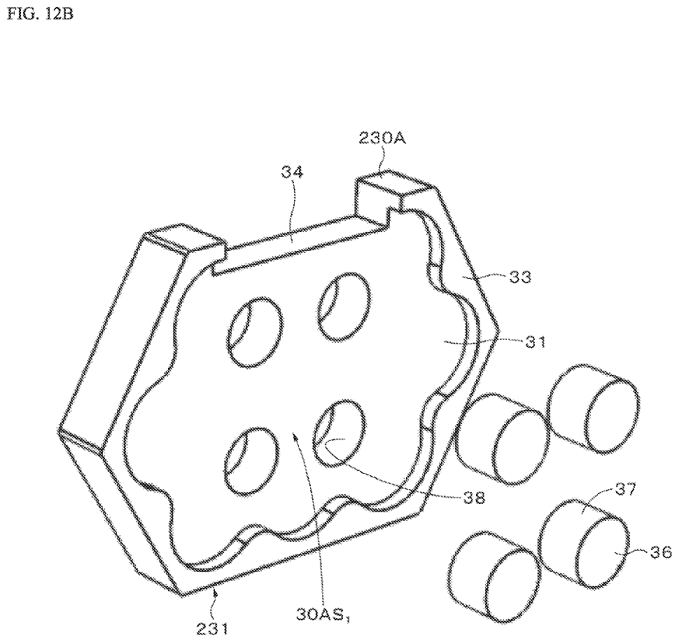

The third embodiment described above has described the case where a foamed resin member 230A has a configuration in which the portion including a flat portion 36 is integrally molded with the other portion; however, the configuration of the foamed resin member 230A is not limited thereto. For example, as shown in FIG. 12A and FIG. 12B, in the foamed resin member 230A, the portion including the flat portion 36 may be separated from other portions. That is, the configuration may be that the foamed resin member constituting the flat portion 31 may be separable from the foamed resin member constituting the flat portion 36.

A foamed resin member 230A includes a main body 231 and one or two or more blocks 37. The main body 231 has one or two or more hole portions 38. The hole portion 38 may be a through hole penetrating from a first main surface portion 30AS₁ toward a second main surface portion 30AS₂, or may be a recess provided in the first main surface portion 30AS₁. The main body 231 is composed of the first foamed resin.

A block 37 is housed in a hole portion 38, and the hole portion 38 is filled with the block 37. The block 37 includes a flat portion 36 and is composed of the second foamed resin having a lower foam density than the first foamed resin. With the configuration as shown in FIG. 12A and FIG. 12B, appropriately changing the block 37 in accordance with the weight of a battery unit 120 can apply a foamed resin member 230A to battery units 120 having different weights.

As described in the above modification example 3 that has described a foamed resin member 230A, a foamed resin member 230B may have the same configuration as the foamed resin member 230A of modification example 3 described above. In addition, in foamed resin members 30A and 30B in the first embodiment, the portion including a protrusion portion 32 may be separated from the other portion as in modification example 3 described above, or in foamed resin members 130A and 130B in the second embodiment, the portion including a recess portion 35 may be separated from the other portion as in modification example 3 described above.

The first to third embodiments described above has described the case where a foamed resin member 30A is provided between a first end surface portion 11A of a case 11 and a first end surface portion 20S₁ of a battery unit 20, and a foamed resin member 30B is provided between a second end surface portion 11B of the case 11 and a second end surface portion 20S₂ of the battery unit 20; however, the arrangement form of the foamed resin member is not limited thereto. A foamed resin member may be further provided between a wall portion 11C of the case 11 and a peripheral surface portion 20S₃ of the battery unit 20. Furthermore, the foamed resin member may be provided all between the inner side surface of the case 11 and the surface of the battery unit 20. In this case, as the foamed resin member, any one of foamed resin members 30A, 130A, and 230A in the first to third embodiments may be used, or two or more thereof may be used in combination.

Any one of the foamed resin members 30A, 130A, and 230A in the first to third embodiments may be provided on one end surface or one side surface of the battery unit 20, or two or more thereof may be provided in combination.

The first to third embodiments described above have described the case where a battery 21 has a cylindrical shape; however, the shape of the battery 21 is not limited thereto, For example, the battery 21 may have a flat shape, a square shape, and a curved shape (arch shape). For example, a laminate battery having a laminate exterior may be used as the flat battery.

The first to third embodiments described above have described the case where battery units 20 and 120 include a plurality of batteries 21; however, the battery units 20 and 120 may include one battery 21. In the present disclosure, the battery unit conceptually includes not only an assembly of a plurality of batteries but also an assembly constituted by one battery and a component such as a tab.

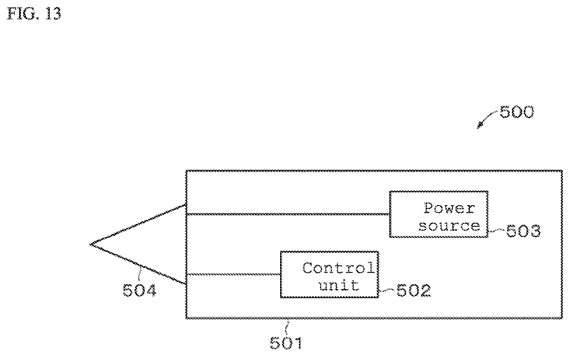

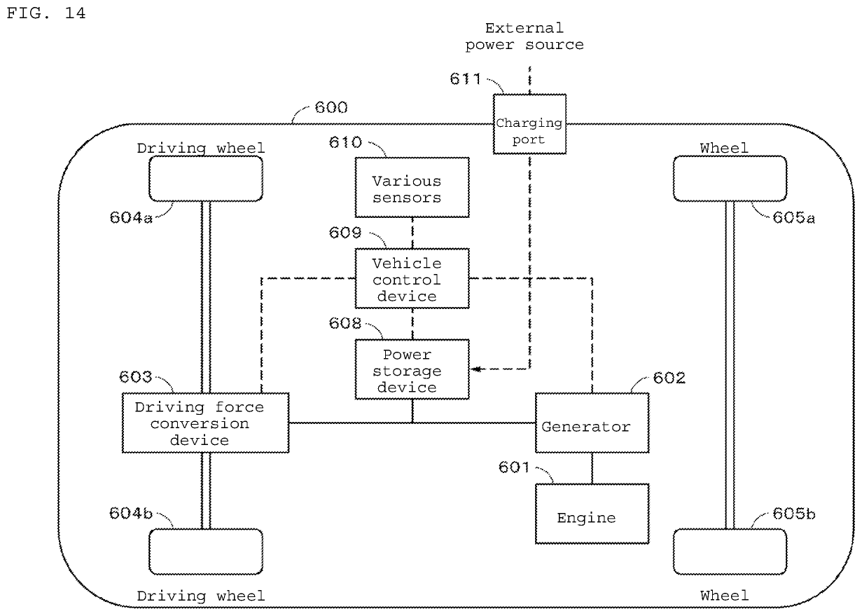

Hereinafter, a power tool 500 including any one of battery packs 10, 110, and 210 according to the first to third embodiments and the modification examples thereof will be described with reference to FIG. 13.

A power tool 500 is, for example, an electric drill, and includes a control unit 502 and a power source 503 inside a tool body 501 formed of, for example, a plastic material. For example, a drill unit 504 as a movable unit is operably (rotatably) attached to the tool body 501.

A control unit 502 controls the operation of the entire power tool (including the use state of a power source 503), and includes, for example, a CPU. The power source 503 includes one or two or more battery packs 10, 110, and 210 according to the first to third embodiments and modification examples thereof. The control unit 502 supplies power from the power source 503 to a drill unit 504 in response to an operation of an operation switch (not shown).

Hereinafter, a power storage system for a vehicle including any one of battery packs 10, 110, and 210 according to the first to third embodiments and modification examples thereof will be described.

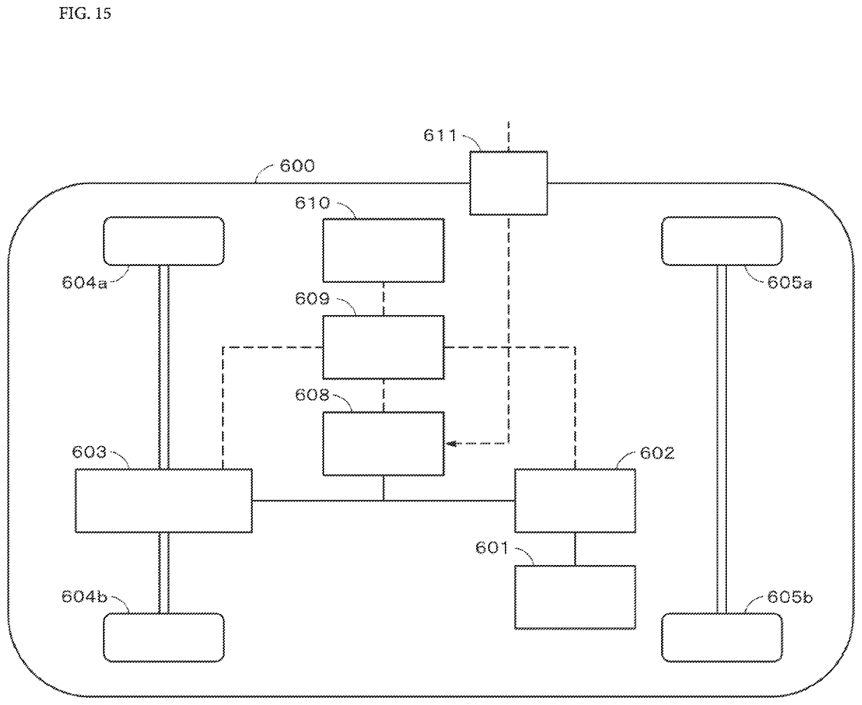

FIG. 14 schematically shows a configuration of a hybrid vehicle that adopts a series hybrid system as a power storage system for a vehicle. The series hybrid system is a system that leads to a run by an electric power-driving force conversion device with using electric power generated by a generator driven by an engine or electric power obtained by temporarily storing the generated electric power in a battery.

This hybrid vehicle 600 mounts an engine 601, a generator 602, an electric power-driving force conversion device 603, a driving wheel 604a, a driving wheel 604b, a wheel 605a, a wheel 605b, a power storage device 608, a vehicle control device 609, various sensors 610, and a charging port 611. The power storage device 608 includes one or two or more battery packs 10, 110, and 210 according to the first to third embodiments and modification examples thereof.

A hybrid vehicle 600 runs by using an electric power-driving force conversion device 603 as a power source. An example of the electric power-driving force conversion device 603 is a motor. The electric power-driving force conversion device 603 operates by the electric power of a power storage device 608, and the rotational force of this electric power-driving force conversion device 603 is transmitted to driving wheels 604a and 604b. Both an AC motor and a DC motor can be used as the electric power-driving force conversion device 603 by using direct current-alternating current (DC-AC) conversion or reverse conversion (AC-DC conversion) where necessary. Various sensors 610 control the engine speed by a vehicle control device 609 and control the opening degree of a throttle valve (throttle opening degree), which is not shown in figure. The various sensors 610 include, for example, a speed sensor, an acceleration sensor, and an engine speed sensor.

The rotational force of an engine 601 is transmitted to a power generator 602, and the electric power generated by the power generator 602 with the rotational force can be stored in a power storage device 608.

When the hybrid vehicle decelerates by a braking mechanism (not shown), a resistance force in deceleration is applied to an electric power-driving force conversion device 603 as a rotational force, and regenerative electric power generated by the electric power-driving force conversion device 603 with the rotational force is stored in a power storage device 608.

A power storage device 608 is connected to an external power source with a charging port 611 interposed therebetween, whereby can receive power supply from the external power source by using the charging port 611 as an input port, and can store the received power.

There may be provided an information processing device that performs information processing related to vehicle control based on information related to the secondary battery, which is not shown in figure. Examples of such an information processing device include an information processing device that displays the remaining battery level based on information on the remaining battery level.

The above-described application example has described a series hybrid vehicle that runs by a motor with using electric power generated by a generator driven by an engine or electric power obtained by temporarily storing the generated electric power in a battery as an example; however, the vehicle that can use the battery according to the present disclosure is not limited thereto. For example, there may be a parallel hybrid vehicle that uses an engine and a motor as drive sources and appropriately switches and uses three types of running only by the engine, running only by the motor, and running by the engine and the motor, or may be an electric vehicle that runs by driving only by the drive motor without using the engine.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery unit including at least one battery;
a case configured to accommodate the battery unit; and
a foamed resin member provided between the battery unit and the case,
wherein the foamed resin member includes a facing portion facing an end surface or a side surface of the battery unit,
wherein the facing portion includes a first surface portion and a second surface portion, and
wherein at least a part of the second surface portion is harder than the first surface portion and is configured to support the battery unit.

2. The battery pack according to claim 1, wherein a foam density of a second foamed resin constituting the second surface portion is lower than a foam density of a first foamed resin constituting the first surface portion.

3. The battery pack according to claim 1, wherein battery unit further includes a holder configured to hold the at least one battery.

4. The battery pack according to claim 2, wherein the battery unit further includes a holder configured to hold the at least one battery.

5. The battery pack according to claim 1, wherein
the foamed resin member has a first protrusion portion protruding toward the battery unit, and
the second surface portion includes the first protrusion portion.

6. The battery pack according to claim 2, wherein
the foamed resin member has a first protrusion portion protruding toward the battery unit, and
the second surface portion includes the first protrusion portion.

7. The battery pack according to claim 3, wherein
the foamed resin member has a first protrusion portion protruding toward the batter unit, and
the second surface portion includes the first protrusion portion.

8. The battery pack according to claim 1, wherein
the battery unit has a second protrusion portion protruding toward the foamed resin member, and
at least a part of the second surface portion is in contact with the second protrusion portion.

9. The battery pack according to claim 2, wherein
the battery unit has a second protrusion portion protruding toward the foamed resin member, and
at least a part of the second surface portion is in contact with the second protrusion portion.

10. The battery pack according to claim 3, wherein
the battery unit has a second protrusion portion protruding toward the foamed resin member, and
at least a part of the second surface portion is in contact with the second protrusion portion.

11. The battery pack according to claim 8, wherein
the foamed resin member has a first recess portion that is recessed in a direction away from the battery unit and accommodates the second protrusion portion, and
the first recess portion includes the second surface portion.

12. The battery pack according to claim 1, wherein
the first surface portion is configured to be elastically deformable, and
at least a part of the second surface portion is plastically deformed.

13. The battery pack according to claim 1, wherein the foamed resin member includes at least one selected from the group consisting of a polyphenylene ether-based resin, a polystyrene-based resin, an olefin-based resin, and combinations thereof.

14. The battery pack according to claim 1, wherein the foamed resin member is formed of foamed beads.

15. The battery pack according to claim 1, wherein a second foamed resin constituting the second surface portion is separable from a first foamed resin constituting the first surface portion.

16. A power tool comprising the battery pack according to claim 1.

17. An electric vehicle comprising the battery pack according to claim 1.
